(19) United States
(12) Patent Application Publication
(10) Pub. No.: US 2008/0057760 A1
(43) Pub. Date: Mar. 6, 2008

(54) Electrical card connector

(75) Inventors: JinSong Tian, Shanghai (CN); HuaiYu Sun, Shanghai (CN)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/899,089

(22) Filed: Sep. 4, 2007

(30) Foreign Application Priority Data
Sep. 4, 2006 (CN) 200620139507.6

(51) Int. Cl. H01R 13/62

(52) U.S. Cl. 439/159; 439/630

(57) ABSTRACT

An electrical card connector comprises a shield housing, an insulation body, a plurality of conductive terminals received in the insulation body, and a card ejection mechanism. The shield housing covers the insulation body and the card ejection mechanism. An elastic pressing part extends from the shield housing. The card ejection mechanism comprises a card ejection sliding block, and an arresting part selectively locating the relative sliding position of the card ejection sliding block. The card ejection sliding block has a positioning track defining a heart-shaped cam and including a card ejection track. An elastic pressing part extends from the shield housing, and is slanted towards the card ejection track. The pressing part has a connection portion extending from the shield housing, a slanting portion extending from the connection portion and a pressing portion extending from the slanting portion. The elastic pressing part presses the follower. The electrical card connector has the advantages of a stable card lock and a longer working life.

### FIELD OF THE INVENTION

The present invention relates to an electrical card connector, and more particularly to an electrical connector including a card ejection mechanism.

### BACKGROUND OF THE INVENTION

As shown in FIGS. 1(a), 1(b) and 1(c), a conventional electrical card connector 7 comprises a housing 70, an insulation body 71, a plurality of conductive terminals 72 received in the insulation body 71, and a card ejection mechanism 73. Referring to these figures, the card ejection mechanism 73 comprises a base 74, a card ejection sliding block 75 permitting relative motion between it and the base 74 and contact with an inserted electrical card C, a spring 76 able to elastically force the card ejection sliding block 75 to return an original position, and an arresting part 77 capable of selectively defining the relative positions between the card ejection sliding block 75 and the base 74. The card ejection sliding block 75 comprises a pushing portion 750 directly moved by the electrical card C and a movable portion 751 disposed in the base 74 synchronically moving with the pushing portion 750. The arresting part 77 is a C-shaped rod, and has a movable follower 770 disposed in the movable portion 751 and a pivotal part 771 pivoting on the base 74. A positioning track 78, a concave portion of the movable portion 751, permits a relative motion between it and the follower 770 of the arresting part 77. The positioning track 78 comprises a common track 780, a card insertion track 781, a card lock track 782, and a card ejection track 783.

When the electrical card C has not been inserted yet, the follower 770 of the arresting part 77 is located at an ejection position 784 on the common track 780. Then, the front end of the electrical card C pushes the pushing portion 750 so that the card ejection sliding block 75 accompanying the electrical card C is moved when the electrical card C is inserted. Accordingly, the follower 770 of the arresting part 77 slides from the common track 780 into the card insertion track 781, and then is guided into the card lock track 782 until the electrical card C is stopped. At this moment, the follower 770 is located at the predetermined lock position 785 of the card lock track 782. If a user does not force the electrical card C, the tensile force of the spring 76 pushes the card ejection sliding block 75 backwards to travel an interval so that the follower 770 is held at a card lock position 786 by following the guidance of the card lock track 782. The arresting part 77 and the spring 76 respectively apply balanced force to the card ejection sliding block 75 to place the electrical card C in a proper position. When the user wants to eject the electrical card C, he has to push the electrical card C again so that the follower 770 leaves the card lock position 786 and enters the card ejection track 783. When the user stops pushing the electrical card C, the tensile force of the spring 76 urges the card ejection sliding block 75 to return until the follower 770 reaches the ejection position 784 of the common track 780 by moving backwards along the card ejection track 783.

As the aforesaid paragraphs mentioned, the follower 770 of the arresting part 77 is moved by the card ejection sliding block 75 so that it has a motion relative to the positioning track 78. To prevent the follower 770 from escaping out of the positioning track 78, an elastic pressing part 700 provided on the housing 70 can ensure that it has a proper motion. The elastic pressing part 700 extends from the opening of the housing 70 to the top of the arresting part 77 opposite the insertion side 702, and applies positive resilient force to the arresting part 77. When the user inserts the electrical card C by an overload force or an inadequate action, the follower 770 of the arresting part 77 is not locked during the movement from the entrance of the card insertion track 781 to the card lock position 786 until it directly enters the card ejection track 783. On the other hand, if the electrical card C is repeatedly inserted into and ejected from the electrical card connector 7, the positioning track 78 will be worn accordingly. That is, the card lock position 786 gets wider than the size of the follower 770. Consequently, the follower 770 will pass the card lock position 786 to arrive on the card ejection track 783 when the follower 770 slides towards the card lock track 782. Unfortunately, the electrical card C cannot be properly held at the card lock position 786, and a wrong card ejection occurs.

In view of the above, the conventional electrical card connector urgently needs to be improved to enhance its performance and working life.

### SUMMARY OF THE INVENTION

The present invention provides a reliable electrical card connector for solving the problem of instability in the card lock that occurs after it has been used many times. The card lock performance is improved through a simple change.

The present invention provides an electrical card connector comprising a shield housing, an insulation body, a plurality of conductive terminals received in the insulation body, and a card ejection mechanism. The shield housing covers the insulation body and the card ejection mechanism. An elastic pressing part extends from the shield housing. The card ejection mechanism comprises a card ejection sliding block and an arresting part selectively locating the relative sliding position of the card ejection sliding block. A positioning track is provided on the card ejection sliding block comprising a card insertion track and a card ejection track. The elastic pressing part includes a pressing surface facing towards the card ejection track. The pressing surface presses the arresting part.

In an embodiment, the pressing part has a connection portion, a slanting portion extending from the connection portion and a pressing portion extending from the slanting portion. A pressing surface is provided on the pressing portion. The slanting portion is bent toward the card ejection track from the connection portion. An opening is provided on the shield housing. The connection portion of the pressing part extends from a side of the opening. The card ejection sliding block includes a surface having a concave portion on which the positioning track is located, and the pressing surface of the pressing part is slanted towards the surface. The arresting part includes a movable follower retained by the positioning track. The pressing surface of the elastic pressing part presses the follower. In another embodiment, the card ejection mechanism further includes a base and at least a return part. The card ejection sliding block can be slidably disposed on the base. The return part returns the card ejection sliding block to a home position. The positioning track further includes a common track parallel to the direction of the movement of the electrical card. The card insertion track and the card ejection track respectively extend from the common track to two opposite sides, and have an ejection position and a lock position.

The elastic pressing part of the card ejection mechanism of the present electrical card connector extends from the shield housing and is slanted towards the card ejection track. When the arresting part arrives at the lock position, the elastic pressing part reversely exerts a force on it to prevent the follower of the arresting part from escaping out of the lock position and improperly entering the card ejection track to cause the electrical card to quit the connector. Therefore, the present electrical card connector ensures that the card is stably locked. The electrical card connector has the advantages of a simple fabrication, a stable card lock and a longer working life.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1(a) is a stereogram of the conventional electrical card connector;

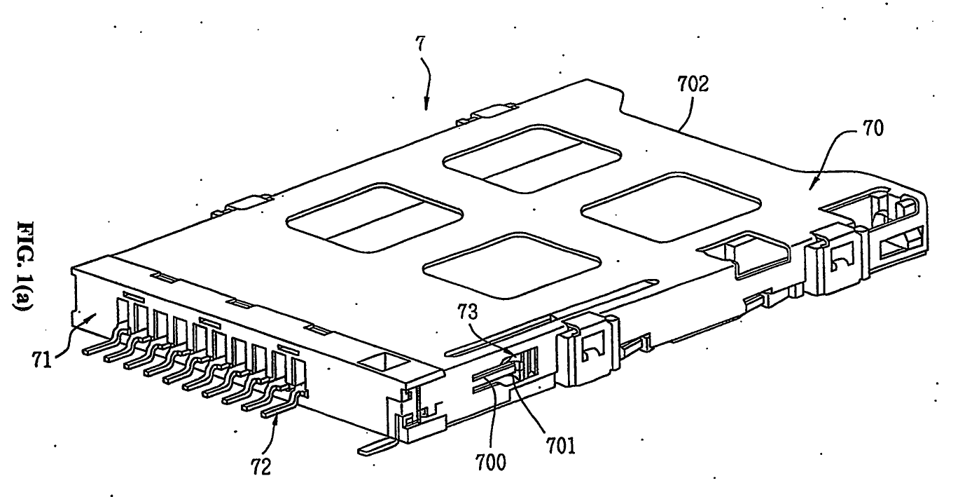

FIG. 1(b) is a plan view of the electrical connector of FIG. 1 without a housing into which an electrical card is inserted;

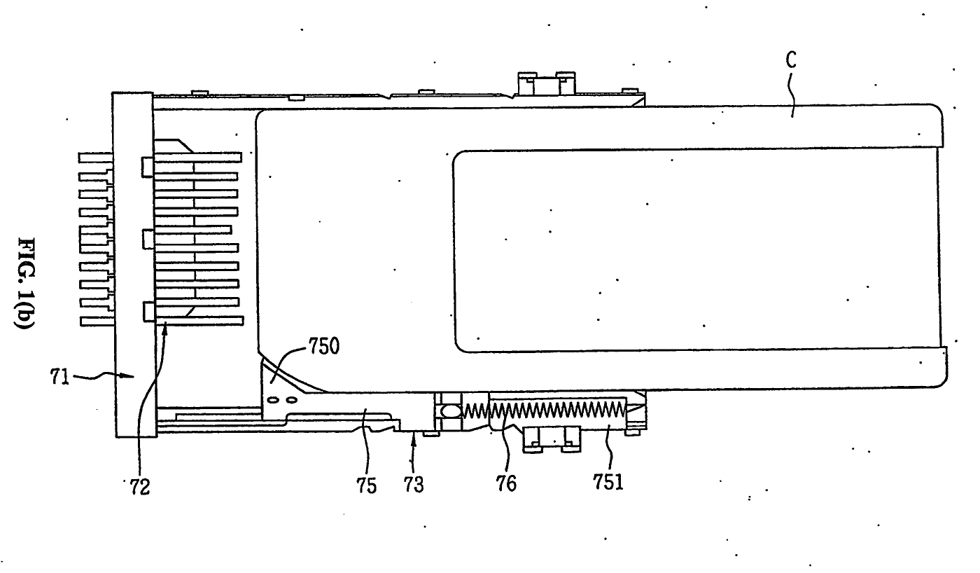

FIG. 1(c) is a side view of the electrical connector of FIG. 1 without a housing;

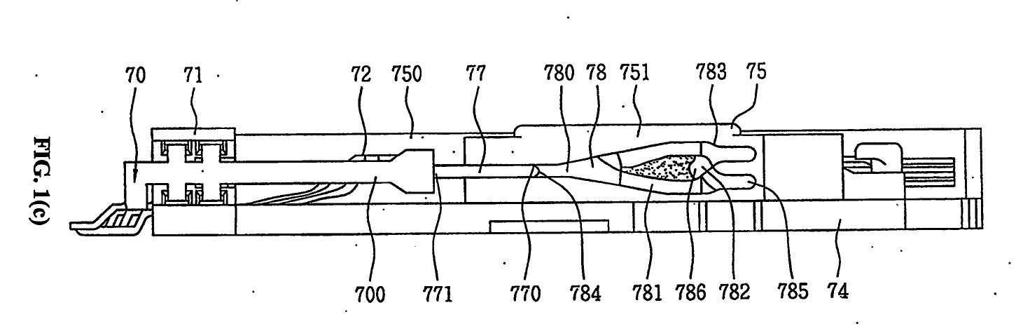

FIG. 2 is a stereogram of an electrical card connector in accordance with the present invention;

FIG. 3 is a plan view of the electrical card connector in FIG. 2;

FIG. 4 is an exploded view of the electrical card connector in FIG. 2;

FIG. 5 is a plan view of the electrical card connector without a shield housing in FIG. 3;

FIG. 6 is a cross-sectional view of the electrical card connector in FIG. 3 along the line of AA;

FIG. 7 is a stereogram of the card ejection sliding block of the card ejection mechanism of an electrical card connector in accordance with the present invention;

FIG. 8 is a schematic diagram showing relative positions of the elastic pressing part and the card ejection sliding block; and

FIG. 9 is a schematic diagram showing the positioning track of the card ejection sliding block.

### DETAILED DESCRIPTION OF THE DISCLOSED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

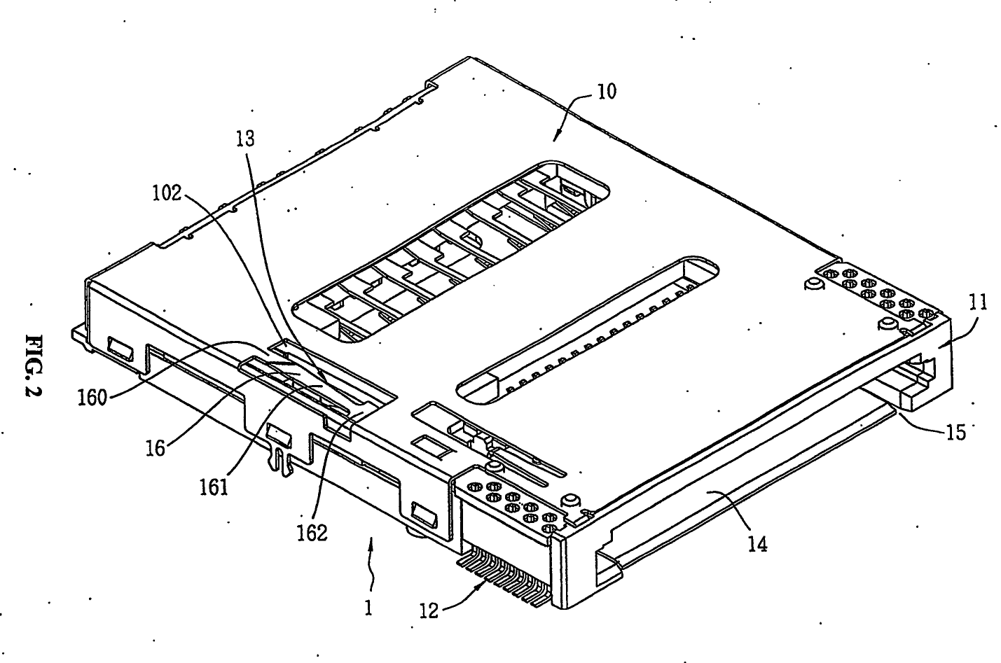

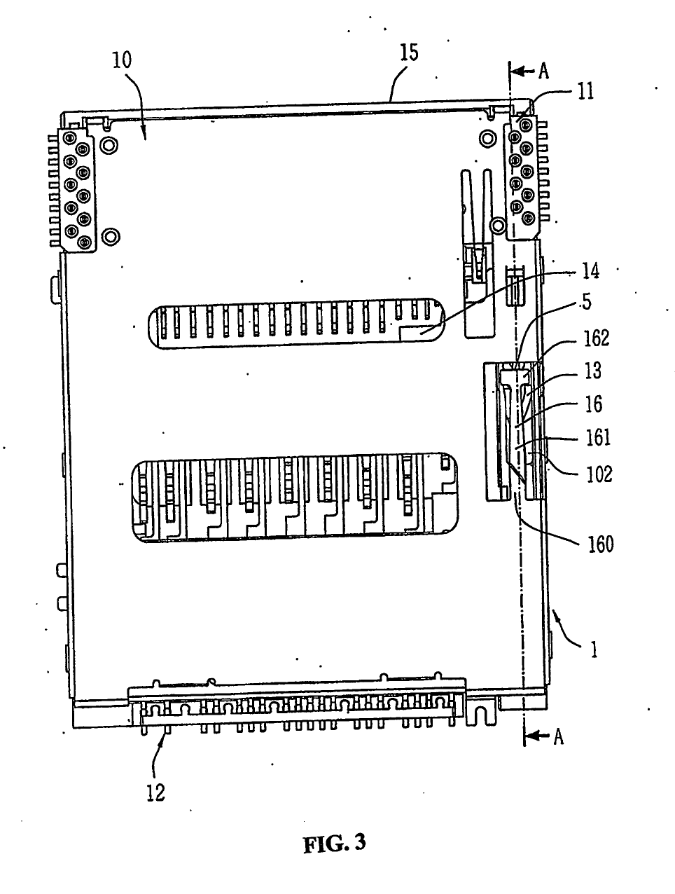

As shown in FIGS. 2 and 3, an electrical card connector 1 according to an embodiment of the present invention includes a shielding housing 10, at least an insulation body 11, a plurality of conductive terminals 12 received and retained in the insulation body 10 and a card ejection mechanism 13. The shielding housing 10 covers the insulation body 11 and the card ejection mechanism 13. A receptacle room 14 is enclosed by the shielding housing 10 and the insulation body 11 in order to permit the insertion of an electrical card (not shown in these figures) from the insertion side 15.

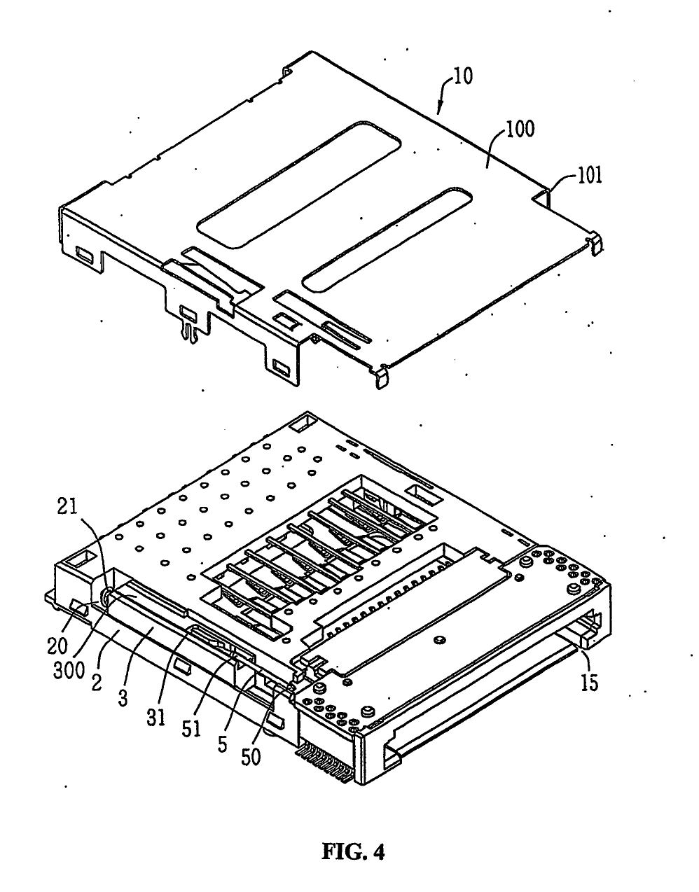

As shown in FIG. 4, the shielding housing 10 comprises a rectangular-shaped upper cover 100 and sidewalls 101 extending downwardly from the two longitudinal sides of the upper cover 100.

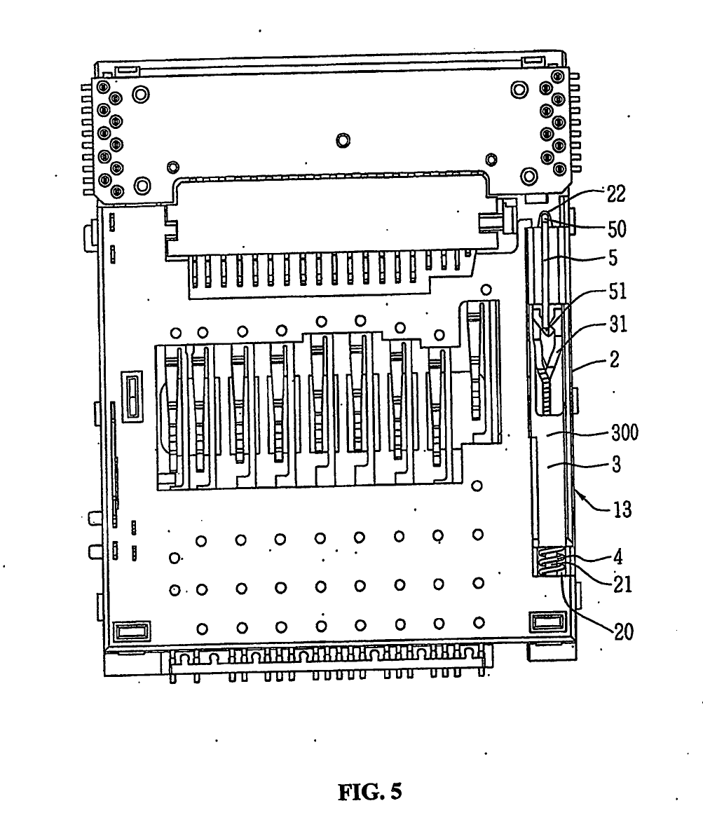

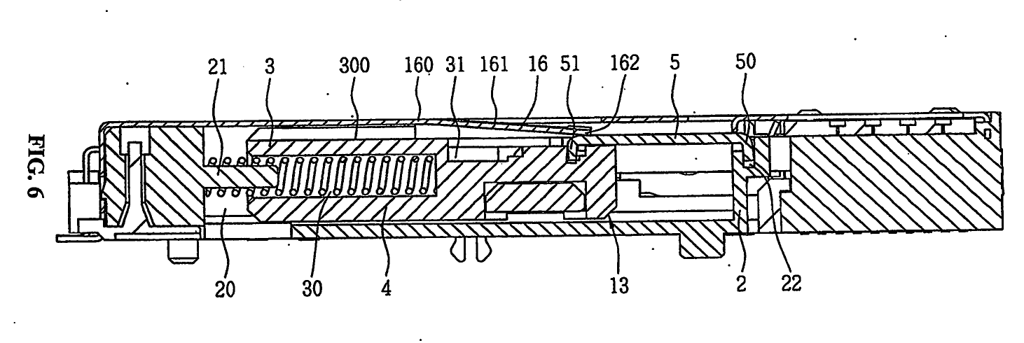

Further referring to FIGS. 4, 5 and 6, the card ejection mechanism 13 comprises a base 2, a card ejection sliding block 3 having a relative sliding motion between it and the base 2 resulting from contact with an inserted electrical card and a return part 4 capable of returning the card ejection sliding block 3 to a home position, and an arresting part 5 capable of selectively defining the relative positions between the card ejection sliding block 3 and the base 2.

The base 2 extends along the insertion direction of the electrical card connecter, and a sliding room 20 is provided on a concave of the base 2 to permit the card ejection sliding block 3 to slide therein. A rod 21 protrudes towards the sliding room 20 from a rear wall (the insertion side 15 is a front side and a side opposite the insertion side 15 is a rear side; hereinafter named the same) of the sliding room 20. A snap hole 22 is downwardly formed from the upper surface of the front side of the base 2.

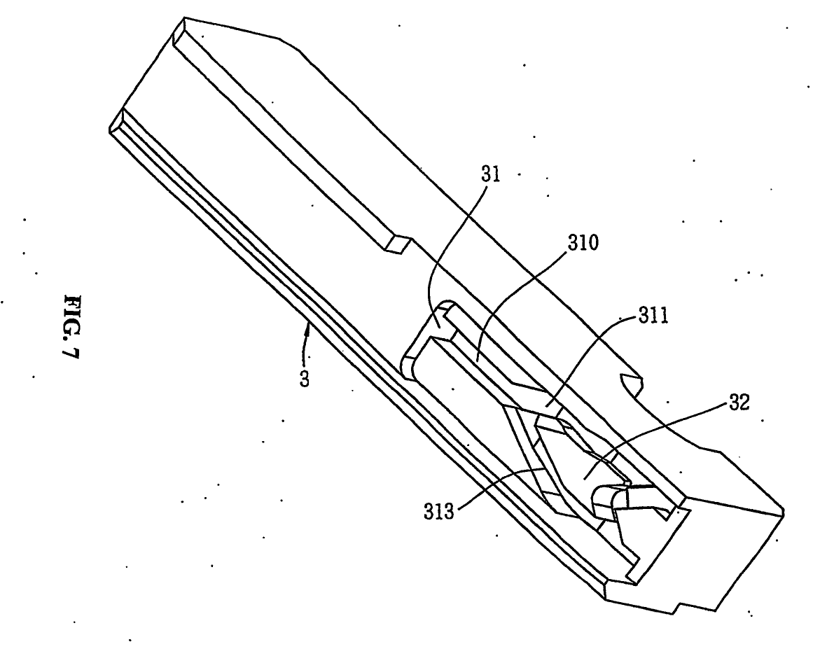

A receptacle groove 30 is concaved on the rear of the card ejection sliding block 3. A positioning track 31 is formed by concaving the front of the card ejection sliding block 3 from the upper surface 300 to the lower surface. As shown in FIG. 7, the positioning track 31 comprises a common track 310, a card insertion track 311, and a card ejection track 313. The common track 310 extends towards a side opposite the insertion side, and its longitudinal direction is parallel to the insertion direction of the electrical card. The card insertion track 311 and the card ejection track 313 respectively extend from the common track 310 to two opposite sides so that a heart-shaped cam 32 is defined by the positioning track 31.

The return part 4 is a spring received between the receptacle groove 30 of the card ejection sliding block 3 and the rear wall of the sliding room 20, and it is an end that holds the rod 21 to be positioned.

The arresting part 5 is C-shaped, and has a pivotal part 50 pivoted in the snap hole 22 of the base 2 and a follower 51 movably disposed in the positioning track 31.

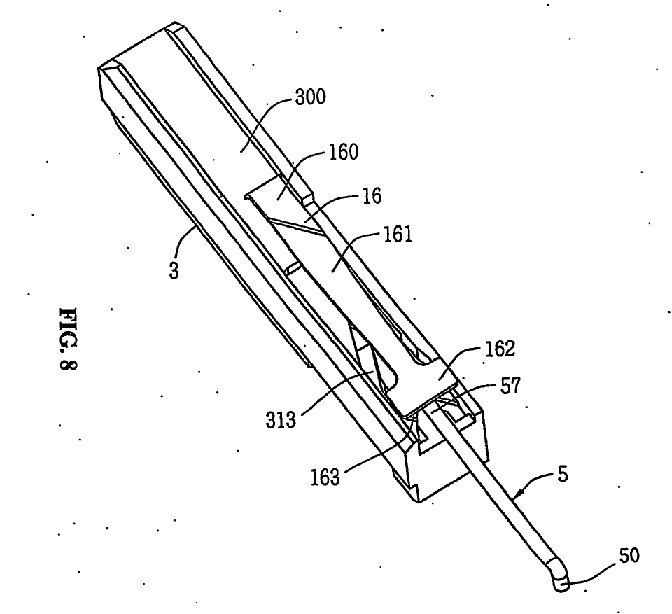

Further referring to FIGS. 2, 3 and 6, to prevent the follower 51 of the arresting part 5 from escaping out of the positioning track 31, the electrical card connector 1 of this embodiment has an opening 102 provided on the upper cover 100 and corresponding to the card ejection mechanism 13, and an elastic pressing part extends from the rear of the opening 102 towards the front of the opening 102 closed to the card ejection sliding block 3. Further referring to FIG. 8, the elastic pressing part 16 includes a connection portion 160, a slanting portion 161 and a pressing portion 162. The slanting portion 161 is bent toward the card ejection mechanism 13 from the connection portion 160, and its extension surface is tilted towards a side adjacent to the card ejection track 313. The pressing portion 162 extends from the edge of the slanting portion 161, and has a pressing surface 163 pressing the follower 51 of the arresting part 5. The pressing surface 163 is slanted towards the upper surface 300 of the card ejection sliding block 3, and is adjacent to the card ejection track 313. Furthermore, the pressing surface 163 bias presses the follower 51 of the arresting part 5.

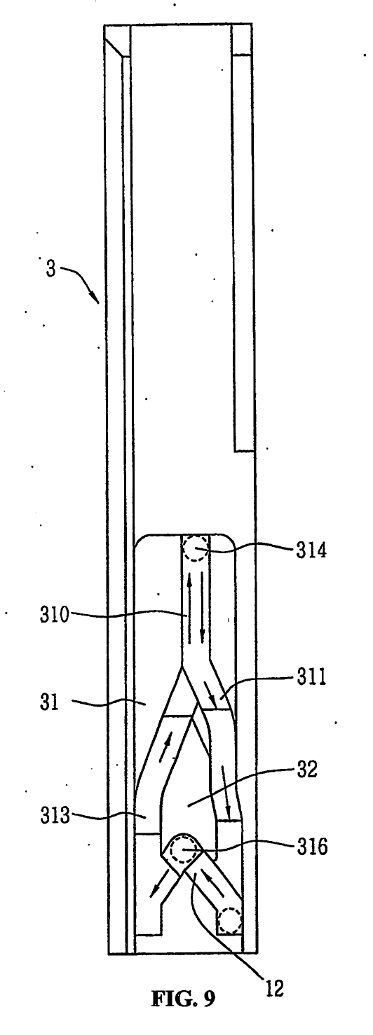

As shown in FIG. 9, the follower 51 of the arresting part 5 is located at an ejection position 314 of the common track 310, when the electrical card is not inserted. During the insertion of the electrical card, the card ejection sliding block 3 starts to compress the spring 4 because the electrical card drives the card ejection sliding block 3 to slide. The follower 51 of the arresting part 5 slides from the lead of the common track 310 into the card insertion track 311 under the press of the pressing surface 163 until the electrical card C cannot move. Meanwhile, the follower 51 of the arresting part 5 is guided by the card insertion track 311 and enters the card lock track 316. The arresting part 5 and the spring 4 respectively apply balanced force to the card ejection sliding block 3 to place the electrical card C inserted into the electrical card in a proper position. During this operation, when the follower 51 of the arresting part 5 enters the lock position 316 out from the card insertion track 311, the elastic pressing part 16 applies force on the follower 5 towards the right side, which is the direction of the card insertion track 311 from the card ejection track 313. Consequently, the follower 51 cannot pass the card lock position 316, and directly enters the card ejection track 313. This is, when the follower 51 enters the card insertion track 311 from the card insertion track 311, it is prevented from passing the lock position 316 and improperly entering the card ejection track 313 to cause the electrical card to quit the connector. Therefore, the present electrical card connector 1 ensures that the card is stably locked.

While a preferred embodiment of the invention is shown and described, it is envisioned that those skilled in the art may devise various modifications without departing from the spirit and scope of the foregoing description and the appended claims.

What is claimed is:

1. An electrical card connector, comprising a shield housing, an insulation body, a plurality of conductive terminals received in the insulation body, and a card ejection mechanism, the shield housing covering the insulation body and the card ejection mechanism, the card ejection mechanism comprising a card ejection sliding block and an arresting part selectively locating a relative sliding position of the card ejection sliding block, the card ejection sliding block comprising a card insertion track and a card ejection track, an elastic pressing part extending from the shield housing and including a pressing surface facing towards the card ejection track and pressing the arresting part.

2. The electrical card connector of claim 1, wherein the pressing part has a connection portion, a slanting portion extending from the connection portion and a pressing portion extending from the slanting portion, and the pressing surface is provided on the pressing portion.

3. The electrical card connector of claim 2, wherein the slanting portion is bent toward the card ejection track from the connection portion.

4. The electrical card connector of claim 2, wherein the shield housing includes an opening, and the connection portion of the pressing part extends from a side of the opening.

5. The electrical card connector of claim 1, wherein the card ejection sliding block includes a surface having a concave portion on which the positioning track is located, and the pressing surface of the pressing part is slanted towards the surface.

6. The electrical card connector of claim 1, wherein the arresting part includes a movable follower retained by the positioning track and the pressing surface of the elastic pressing part presses the follower.

7. The electrical card connector of claim 1, wherein the card ejection mechanism further includes a base and at least a return part, the card ejection sliding block can be slidably disposed on the base, and the return part returns the card ejection sliding block to a home position.

8. The electrical card connector of claim 1, wherein the positioning track further includes a common track parallel to the direction of the movement of the electrical card, and the card insertion track and the card ejection track respectively extends from the common track to two opposite sides and have an ejection position and a lock position.
